(19) United States
(12) Patent Application Publication
(10) Pub. No.: US 2005/0035982 A1
(43) Pub. Date: Feb. 17, 2005

(54) Display apparatus and control method thereof

(75) Inventors: Yun-ju Hong, Suwon city (KR); Young-chan Kim, Euiwang city (KR); Jae-hyung Chang, Seongnam city (KR); Heung-jun Park, Seoul City (KR); Jun-seong Lee, Hwasung city (KR); Dong-hoon Lee, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/832,345

(22) Filed: Apr. 27, 2004

(30) Foreign Application Priority Data
Aug. 11, 2003 (KR) 2003-55449

(51) Int. Cl. G09G 5/02

(52) U.S. Cl. 345/698

(57) ABSTRACT

A display apparatus including a panel to display images, a panel driver to control the panel to display the images, a scaler to process an input image signal according to a previously setup resolution, and to transmit the processed signal to the panel driver, an OSD (On Screen Display) controller to display an OSD message on the panel, and a control part to control the scaler to skip the input image signal in a regular interval and to transmit the processed signal to the panel driver, and to control the OSD controller to display the OSD message warning a frequency over range status, in response to a frequency of the input image signal exceeding a range of the previously setup resolution.

### CROSS-REFERENCE TO RELATED APPLICATIONS

This application claims the benefit of Korean Patent Application No. 2003-55449, filed Aug. 11, 2003, in the Korean Intellectual Property Office, the disclosure of which is incorporated herein by reference.

### BACKGROUND OF THE INVENTION

1. Field of the Invention

The present invention relates to a display apparatus and a control method thereof, and, more particularly, a display apparatus and a control method informing a user that a current size of a screen is downscaled.

2. Description of the Related Art

A display apparatus processes an input image signal according to a previously setup resolution, and displays the processed signal as an image on a screen. Here, the display apparatus, providing a multi-mode function, can display any image signal as long as a frequency of the image signal is within a range of the previously setup resolution which the display apparatus can support.

If the frequency of the input image signal is over the range of the previously setup resolution, the display apparatus displays a black screen and warns a user that the frequency of the input image signal exceeds the range by displaying a frequency over range message using an OSD (On Screen Display). In this case, however, the user is not able to see information about the image on the screen at all.

Recently, in order to overcome this problem, a downscaling function has been applied to the display apparatus so that if the frequency of the input image signal exceeds the range of previously setup resolution, the input image signal is partially skipped in a regular interval and displayed on the screen. However, the input image signal data gets damaged because its frequency is partially skipped, so that the user cannot obtain high resolution images. Therefore, the user needs to be informed that the downscaling function is applied, so that the user can change the previously setup resolution to a resolution value which the display apparatus supports.

### SUMMARY OF THE INVENTION

Accordingly, it is an aspect of the present invention to provide a display apparatus and a control method thereof to inform a user that a current screen status is in a downscaling mode.

Additional aspects and/or advantages of the invention will be set forth in part in the description which follows and, in part, will be obvious from the description, or may be learned by practice of the invention.

The foregoing and/or other aspects of the present invention are achieved by providing a display apparatus comprising a panel to display images; a panel driver to control the panel to display the images; a scaler to process an input image signal according to a previously setup resolution, and to transmit the processed signal to the panel driver; an OSD (On Screen Display) controller to display an OSD message on the panel; and a control part to control the scaler to skip the input image signal in a regular interval and to transmit the processed signal to the panel driver, and to control the OSD controller to display the OSD message warning a frequency over range status, in response to a frequency of the input image signal exceeding a range of the previously setup resolution.

According to an aspect of the present invention, the OSD message may display a resolution value for a frequency of the input image signal and a recommended value of resolution which the display apparatus supports.

According to an aspect of the present invention, the display apparatus may further comprise a key input part to generate a key input signal in real time by a user's operation, wherein the control part controls the OSD controller to stop displaying the OSD message in response to the key input signal being newly inputted through the key input part.

According to an aspect of the present invention, the control part may control the OSD controller to stop displaying the OSD message after a predetermined time has elapsed.

According to another aspect of the present invention, the foregoing and/or other aspects may be achieved by providing a control method of a display apparatus comprising a panel to display images; a panel driver to control the panel to display the images; and a scaler to process an input image signal according to a previously setup resolution and to transmit the processed signal to the panel driver, the control method comprising: determining whether a frequency of the input image signal exceeds a range of the previously setup resolution; skipping the input image signal in a regular interval, and transmitting the processed signal in response to the frequency of the input image signal exceeding the range of the previously setup resolution; and displaying an OSD message on the panel warning that the frequency of the input image signal is in a frequency over range status.

According to an aspect of the present invention, the OSD message may display a resolution value for a frequency of the input image signal and a recommended value of resolution which the display apparatus supports

According to an aspect of the present invention, the control method of the display apparatus may further comprise determining an elapsed time after the OSD message is displayed on the panel; and stopping displaying the OSD message after a predetermined time has elapsed.

According to another aspect of the present invention, the control method of the display apparatus may further comprise determining whether a new key input signal is generated in real time by a user after the OSD message is displayed; and stopping displaying the OSD message in response to the new key input signal being generated.

### BRIEF DESCRIPTION OF THE DRAWINGS

These and/or other aspects and advantages of the invention will become apparent and more readily appreciated from the following description of the embodiments, taken in conjunction with the accompany drawings of which:

FIG. 1 is a block diagram of a display apparatus according to an embodiment of the present invention;

FIG. 2 is an example of an OSD message displayed on a screen of the display apparatus, informing a user that a frequency is in over range status; and

FIG. 3 is a control flow of the display apparatus in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

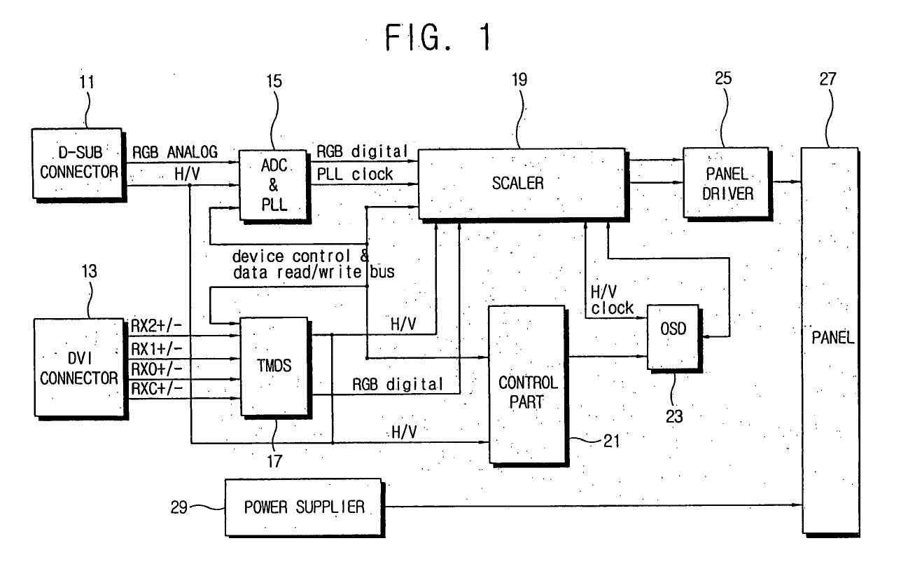

As shown in FIG. 1, a display apparatus according to an embodiment of the present invention comprises a panel 27 displaying images; a panel driver 25 controlling the panel 27 to display the images; an OSD (On Screen Display) controller 23 displaying an OSD menu on the panel 27; a scaler 19; and a control part 21. A key inputting part (not shown) is also included in the display apparatus, so that a user can generate input signals in real time.

The scaler 19 processes an input image signal according to a previously setup resolution, and transmits the processed signal to the panel driver 25. If the input image signal is an analog image signal, it is transmitted to an A/D (Analog/Digital) converter 15 through a D-SUB connector 11. The A/D converter 15 then converts the analog image signal into a digital image signal, and transmits the digital image signal to the scaler 19. If the input image signal is a digital signal, it is transmitted to a TMDS (Transition Minimized Differential Signaling) part 17 through the DVI (Digital Visual Interface) connector 13, and the TMDS part 17 converts the digital signal into the digital image signal and transmits the digital image signal to the scaler 19. The digital signal inputted through the DVI connector 13 is a digital signal that is divided according to channels. The digital image signal converted by the TMDS part 17 includes digital R, G, B and HN synchronous signals. A graphics card of a computer may divide the digital R, G, B, signal and HN synchronous signals according to the channels, and transmit the divided digital signal to the display apparatus through a DVI Interface. The TMDS part 17 converts the divided digital signal into the R, G, B signal and HN synchronous signals.

The digital image signal is transmitted to the scaler 19 based on horizontal/vertical synchronized signals, and the scaler 19 performs a downscaling function which partially skips the input image signal in a regular interval, and transmits the downscaled signal to the panel driver 25, if the control part 21 determines the frequency of the input image signal is exceeding the range of the previously setup resolution.

The control part 21 controls the scaler 19 to perform the downscaling function if the frequency of the input image signal exceeds the range of the previously setup resolution, and controls the OSD controller 23 to display an OSD message that warns of a frequency over range status on the panel 27.

The OSD message displays information of a proper resolution for a frequency of a current input image signal, as well as a recommended value of resolution which the display apparatus supports.

The control part 21 controls the OSD controller 23 to display the OSD message when the frequency of the input image signal exceeds the previously setup resolution, and to stop displaying the OSD message if a new key input signal is inputted through the key input part. The control part 21 controls the OSD controller 23 to stop displaying the OSD message displayed on the panel 27 after a predetermined time has elapsed.

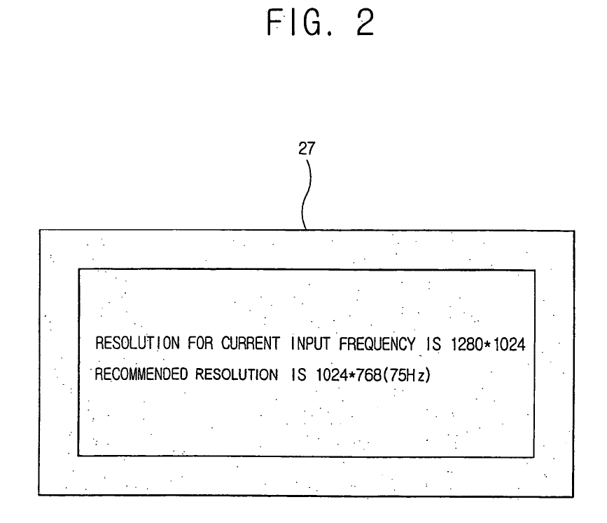

As shown in FIG. 2, the OSD message displays information about the proper resolution for the frequency of the current input image signal, and the recommended value of resolution which the display apparatus supports as well. The recommended value provides optimized resolution for each screen size, and is set as a maximized resolution for the display apparatus, but is not necessarily limited to the recommended resolution.

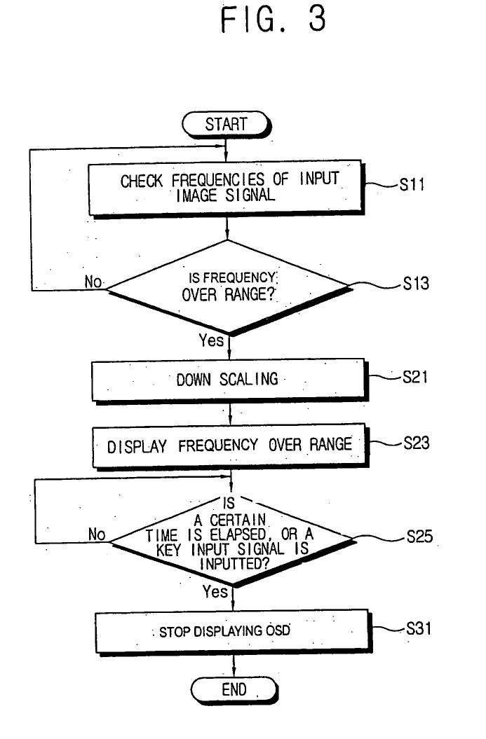

Referring to FIG. 3, a detailed description of a control flow according to an embodiment of the present invention will be described hereafter.

An analog image signal is applied to the A/D converter 15 through the D-SUB connector 11, or a digital signal is applied to the TMDS 17 part through the DVI connector 13, and then each of the signals is converted into a digital image signal, respectively. The scaler 19 receives the digital image signal and transmits it to the panel driver 25 after completing processing of the digital image signal according to the previously setup resolution.

The control part 21 checks the frequency of the input image signal at operation S11, and controls the scaler 19 to partially skip the input image signal in a regular interval, and transmit the downscaled image to the panel driver 25, if the frequency of the input image signal is determined to be exceeding the range of a previously setup resolution, at operation S21.

The control part 21 also controls the OSD controller 23 to display the OSD message on the panel 27 warning that the frequency of the input image signal is over the range of the previously setup resolution, at operation S23.

Herein, the control part 21 checks an elapsed time since the OSD message was displayed on the panel 27 at operation S25, and controls the OSD controller 23 to stop displaying the OSD message after a predetermined time has elapsed, at operation S31. The control part 21 also checks whether or not a key input signal is generated in real time by a user after the OSD message is displayed on the panel 27, at operation S25. If the key input signal is generated, the control part 21 controls the OSD controller 23 to stop displaying the OSD message at operation S31.

According to the above description, the present invention provides a display apparatus and a control method thereof to inform a user that a current screen status is in a downscaling mode.

Although a few embodiments of the present invention have been shown and described, it would be appreciated by those skilled in the art that changes may be made in these embodiments without departing from the principles and spirit of the invention, the scope of which is defined in the claims and their equivalents.

1. A display apparatus comprising:
a panel to display images;
a panel driver to control the panel to display the images;
a scaler to process an input image signal according to a previously setup resolution, and to transmit the processed signal to the panel driver;
an OSD (On Screen Display) controller to display an OSD message on the panel; and
a control part to control the scaler to skip the input image signal in a regular interval and to transmit the processed signal to the panel driver, and to control the OSD controller to display the OSD message warning a frequency over range status, in response to a frequency of the input image signal exceeding a range of the previously setup resolution.

2. The display apparatus according to claim 1, wherein the OSD message displays a resolution value for a frequency of the input image signal and a recommended value of resolution which the display apparatus supports.

3. The display apparatus according to claim 1, further comprising a key input part to generate a key input signal in real time by a user's operation, wherein the control part controls the OSD controller to stop displaying the OSD message in response to the key input signal being newly inputted through the key input part.

4. The display apparatus according to claim 1, wherein the control part controls the OSD controller to stop displaying the OSD message after a predetermined time has elapsed.

5. A control method of a display apparatus comprising a panel to display images, a panel driver to control the panel to display the images, and a scaler to process an input image signal according to a previously setup resolution and to transmit the processed signal to the panel driver, the control method comprising:
determining whether a frequency of the input image signal exceeds a range of the previously setup resolution;
skipping the input image signal in a regular interval, and transmitting the processed signal in response to the frequency of the input image signal exceeding the range of the previously setup resolution; and
displaying an OSD message on the panel warning that the frequency of the input image signal is in a frequency over range status.

6. The control method of the display apparatus according to claim 5, wherein the OSD message displays a resolution value for a frequency of the input image signal and a recommended value of resolution which the display apparatus supports

7. The control method of the display apparatus according to claim 5, further comprising:
determining an elapsed time after the OSD message is displayed on the panel; and
stopping displaying the OSD message after a predetermined time has elapsed.

8. The control method of the display apparatus according to claim 5, further comprising:
determining whether a new key input signal is generated in real time by a user after the OSD message is displayed; and
stopping displaying the OSD message in response to the new key input signal being generated.

9. A display apparatus comprising:
a scaler to downscale an image signal in response to the image signal exceeding a previously determined resolution; and
an OSD controller to display a message warning that the image signal is downscaled.

10. The display apparatus of claim 9, wherein the message further indicates that the image signal exceeds the previously determined resolution.

11. The display apparatus of claim 9, wherein the message further indicates a recommended value of resolution for the image signal.

12. A method of controlling a display apparatus, the method comprising:
downscaling an image signal in response to the image signal exceeding a previously determined resolution; and
displaying a message warning that the image signal is downscaled.

13. The method of claim 12, wherein the message further indicates that the image signal exceeds the previously determined resolution.

14. The method of claim 12, wherein the message further indicates a recommended value of resolution for the image signal.
